(19) United States
(12) Patent Application Publication
(10) Pub. No.: US 2006/0232745 A1
(43) Pub. Date: Oct. 19, 2006

(54) Digital reproduction of variable density film soundtracks

(76) Inventor: Jaime Arturo Valenzuela, Alhambra, CA (US)

Correspondence Address: THOMSON LICENSING INC., PATENT OPERATIONS, PO BOX 5312, PRINCETON, NJ, 08543-5312, US

(21) Appl. No.: 10/553,809

(22) PCT Filed: Feb. 26, 2004
(86) PCT No.: PCT/US04/05690

§ 371 Date: Oct. 18, 2005

Related U.S. Application Data
(60) Provisional application No. 60/467,798, filed on May 2, 2003.

(51) Int. Cl. G03B 31/00

(52) U.S. Cl. 352/5

(57) ABSTRACT

Restoration of audio information embodied on a soundtrack of a motion picture film advantageously occurs by scanning the film with a beam of light to capture the image in the form of a digital signal via an imager. The digital signal undergoes storage in a storage mechanism (300) and subsequent processing via controller. The controller applies one or more statistical processing algorithms to eliminate deficiencies and to enhance the quality of the audio embodied in the soundtrack.

This application claims the benefit, under 35 U.S.C. § 365 of International Application PCT/US2004/005690, filed Feb. 26, 2004, which was published in accordance with PCT Article 21(2) on Nov. 18, 2004 in English and which claims the benefit of U.S. provisional patent application No. 60/467,798, filed May 2, 2003.

### TECHNICAL FIELD

This invention relates to the reproduction of analog optically recorded soundtracks and in particular to the restoration of recorded signal quality in variable density recordings.

### BACKGROUND

Optical recording remains the predominant method for creating an analog motion picture soundtrack. Such optical recording can make use of a variable area method whereby illumination from a calibrated light source passes through a shutter that is modulated with the audio signal. The shutter opens in proportion to the intensity or level of the audio signal and results in the illumination beam from the light source being modulated in width. This varying width illumination exposes a monochromatic photographic film which when processed results in a black audio waveform envelope surrounded at the waveform extremities by a substantially clear or colored film base material. In this way the width of the exposed and developed film represents the instantaneous audio signal amplitude.

A second method exists for recording analog motion picture soundtracks wherein the audio signal causes the total width of the photographic audio track to be variably exposed. With this method, termed “variable density”, the exposure of the complete track width varies in accordance with the amplitude of the audio signal to produce a track which varies in optical transmissivity between a substantially clear or colored base film material having relatively high light transmissivity and low transmission or high density areas of exposed and developed photographic material. Thus the instantaneous audio signal amplitude is represented by a variation in the transmission of illumination though the exposed and developed film track width. This recording method suffers from a poor, low signal-to-noise ratio and signal amplitude distortion resulting from exposing the film into areas where the transfer characteristic exhibits non-linearity. In addition, inter-modulation distortion results as sections of the film track immediately adjacent to the intended exposure areas become affected by both light diffraction around the recording slit and scattering within the film emulsion.

Hence, with either variable density or variable area recording methods, the audio modulation (sound) can be recovered by suitably gathering the illumination transmitted through the soundtrack area, typically by means of a photo detector. FIG. 1 depicts in greatly simplified form an arrangement for recording a variable density analog soundtrack

The aforementioned analog film sound recording techniques incur imperfections caused by physical damage and contamination during recording, printing and subsequent handling of the film. Since these recording techniques use photographic film, the amount of light used in recording (Density) and the exposure time (Exposure) constitute critical parameters. The correct density for recording can be determined by a series of tests to determine the highest and lowest possible densities that fall within the linear portions of the transfer characteristic of the film.

Film stock on which sound is recorded film is generally only sensitive blue illumination. Such film stock typically employs a gray anti-halation dye to substantially reduce or eliminate halation effects. Halation occurs as the result of reflections from the back of the film base causing a secondary, unwanted exposure of the emulsion. Typically, a variable area track has a gamma between 0.5 and 1.6.

The frequency response of the variable density recording method is determined by various parameters, for example, the width of the slit through which the modulated light passes, the exposure of the film, and the Modulation Transfer Function (MTF) of the film which is directly related to light diffusion. The higher the exposure time the lower the frequency bandwidth of the recording.

Optimum density occurs as a result of a compromise among the signal-to-noise ratio, the inter-modulation distortion and non-linear exposures. An optimum density can be determined by test exposures to find an acceptably low value for inter-modulation distortion resulting from image spreading.

In addition to non-linear densities and inter-modulation distortion, other imperfections can result. For example, the density of the exposed or unexposed areas can vary randomly or can vary in sections across or along the soundtrack area. During audio track playback, such density variations directly translate into spurious noise components interspersed with the wanted audio signal.

A further source of audio track degradation occurs as the result of mechanical imperfections variously imparted to the film and/or incurred during reproduction. One such deficiency causes the film, or tracks thereon, to weave or move laterally with respect to a fixed transducer. Film weave can result in various forms of imperfection such as amplitude and phase modulation of the reproduced audio signal.

As discussed, analog optical recording methods remain inherently susceptible to physical damage and contamination of the film during handling. For example, dirt or dust can introduce transient, random noise events. Similarly, scratches in either the exposed or unexposed areas of the film can alter the optical transmission properties of the soundtrack and cause severe transient noise spikes. Furthermore other physical or mechanical consequences, such as the film perforation, improper film path lacing or related film damage can introduce unwanted cyclical repetitive effects into the soundtrack. These cyclical variations can introduce spurious illumination and give rise to a low frequency buzz, for example having an approximately 96 Hz rectangular pulse waveform, rich in harmonics and interspersed with the wanted audio signal. Similarly, picture area light leakage into the soundtrack area can also cause image related audio degradation.

Conventional analog soundtrack readers reproduce the changes in light transmitted through the film together with all its imperfections. Heretofore, such readers have not offered any correction of the variable density track anomalies and deficiencies discussed previously. European patent EP 1091573 teaches compensations for the effects of variations in density or shading due to errors in printing and noise generated by the CCD imager scanning the track. However, the patent fails to address the effects of inter-modulation distortion, and in addition teaches the use of 8-bit signal quantization, which yields an unacceptably low signal-to-noise ratio in the order of 49 dBs.

German patent application DE 197 29 201 A1 discloses a telecine, which scans analog optically recorded soundtracks. The disclosed apparatus scans the sound information signal and applies two-dimensional filtering to the output values. German application DE 197 33 528 A1 describes a system for stereo sound signals. An evaluation circuit provides only the left or the right sound signal or the sum signal of both as a monophonic output signal.

Clearly, a need exists for an arrangement that allows reproduction and processing of analog optically-recorded soundtracks to not only substantially eliminate the noted deficiencies but to enhance the quality of the reproduced audio signal.

### BRIEF SUMMARY OF THE INVENTION

Briefly, in accordance with a first aspect of the present principles, an analog optically recorded variable density soundtrack is restored by use of digital signal processing. An advantageous arrangement employs a line array imager, typically a CCD imager, to scan and form an image of the variable density track for storage as a digital signal for storage in a memory system, typically a hard disk or array of such hard disks. The imager output signal is quantized with at least 12-bit resolution to obtain an acceptable signal-to-noise ratio of approximately 74 dB in the resulting audio signal. An audio signal is extracted from the stored soundtrack image and undergoes statistical processing by use of one or more methods to eliminate deficiencies and restore the quality.

The statistical processing techniques can include one or more of the following:
1) Averaging pixel intensities over each scanned line.
2) Use of standard deviation in each line of scanned data to eliminate extraneous pixel values.
3) Creation of a look-up-table to correct data values derived from non-linear areas of film density transfer characteristic.
4) Statistical and regression analysis of the pixel intensities values to extend beyond non-linear areas of film density transfer characteristic.
5) Adaptive filtering to minimize effects of inter-modulation distortion.

In another aspect of the present principles, the analog variable density optical soundtrack undergoes scanning by a 2048 pixel line scan CCD imager. Light from a light source passes through the soundtrack area of the film, for imaging by, and to substantially fill the width of the of, the CCD imager. The varying density of the soundtrack recording results in a corresponding variation of light imaged by the CCD imager. The output signal from the CCD is quantized with a 12-bit resolution and stored in a storage system, typically in the form of a raid array. The exposure time of the CCD imager is synchronized with bi-phase drive signals that control the film transport; thereby providing an exposure rate of about 30,000 scans per second, which yields a nominal bandwidth of 15 KHz in the resulting soundtrack signal.

To compensate for the effects of film grain or granularity, which result in unwanted signal amplitude variations or random noise, one or more statistical processing methods are used.
1 ) A first method processes the data signal to determine an average value of the film density during each line scan by summing all the pixel values and dividing by 2048. This average or mean value represents a good approximation to the wanted audio amplitude while minimizing the effects of random noise.
2) A second advantageous processing arrangement consists of calculating the standard deviation of each pixel in each line scan and eliminating pixel values that deviate above a user defined threshold. After which the mean is calculated to obtain a noise reduced instantaneous amplitude.
3) A third advantageous processing arrangement employs one or more “look up tables” to correct for exposures or density values that fall in the non-linear toe and the shoulder areas of the log exposure vs. density (H vs. D) curve shown in FIG. 2. The look up tables are constructed using, for example a logarithmic or a cubic polynomial function to linearize the toe area (AB) of the characteristic with exponential and square law functions used to linearize the shoulder part (CD) of the film transfer law. The various correction laws are user selectable to enable comparative evaluation of the processed audio. In addition the user can select the range of pixel values (intensities) that wilt be subject to correction by the selectable look up tables. For example different tables with different correction laws can be chosen for the toe and shoulder regions of the transfer characteristic with the correction cut in point (pixel values) of the imaged signal from the RAID array selected by the user.
4) A fourth advantageous processing arrangement employs a regression analysis technique to linearize the response curves of the optical track. In this arrangement the function shape and the range of pixel intensities are not input by the user, but rather a computer performs a sampling of the overall dynamic range of the track and an estimate of the slope and intercept of the response is calculated. Having determined the equation or mathematical function that the range of pixel values represent, other points beyond the linear range of the film characteristic can be estimated and the overall dynamic range of the track can be extended or linearized. Other linear operations can be performed to this line such as shifting in the X and Y axis by user defined values.
5) The effects of inter-modulation distortion are manifest as an asymmetrical increase of amplitude peaks that is dependent both on frequency and exposure (sound amplitude). Track areas of low density are little affected by inter-modulation distortion. A filter function is formed to subtract a percentage of the measured intensity of both preceding and succeeding scanned lines from any given line. Typically edge diffraction effects yield a sinusoidal drop in intensity thus an advantageous corrective function can be formed with data from adjacent line scans. The range of scanned lines that are to be used to set the coefficients of the filter should be user selectable with the optimum value determined by listening tests. The line scan rate has a great influence on this parameter since a grater number of samples will describe the track with greater accuracy.

In accordance with another aspect of the present principles, an apparatus for the playback of an analog optically recorded soundtrack comprises a transport means for transporting a film having such a soundtrack. A scanning means generates an image signal of the analog optically recorded soundtrack only. An alignment means aligns the scanning means such that the image signal of the soundtrack substantially fills the width of the scanning means. A processor processes the image signal to form an audio output signal.

In accordance with yet another aspect of the present principles, there is provided a method for eliminating positional variations of an analog optically recorded soundtrack on a film. The method comprises the steps of (a) transporting the film which includes a soundtrack with an audio representative envelope that is subject to positional variation, (b) forming a digital image of the soundtrack with said audio representative envelope during transport, (c) aligning the digital image of said soundtrack with an audio representative envelope to assure the positional variation of said soundtrack on the film and peaks of the audio representative envelope remain within the digital image, and (d) processing the digital image to separate only the audio representative envelope and form therefrom an audio output signal.

Another aspect of the present principles facilitates azimuth alignment of a scanning means during soundtrack playback. The apparatus comprises film transport for transporting a film including an analog optically recorded soundtrack. A scanning means generates an image signal of only the soundtrack and is aligned such that an image signal of the soundtrack substantially fills a width of the scanning means. An azimuth aligning means positions the scanning means such that equal density values of the image of said soundtrack are displayed concurrently with substantially the same brightness.

### BRIEF DESCRIPTION OF THE DRAWINGS

FIG. 1 illustrates a diagrammatic representation of an analog variable density soundtrack recording method;

FIG. 2 illustrates a plot of log exposure (H) versus density (D);

FIG. 3 illustrates a block diagram of a system for processing optically recorded analog soundtracks in accordance with the present principles;

FIG. 4 illustrates a segment of an analog variable density soundtrack to showing the causes of inter-modulation distortion;

FIG. 5 illustrates a scanned gray scale image of an analog variable density soundtrack that is subject to certain deficiencies;

FIG. 6 illustrates a control panel used in accordance with the processing system of FIG. 3;

FIG. 7A illustrates a flowchart representing a sequence of steps associated with azimuth alignment in accordance with the present principles;

FIG. 7B illustrates a flow chart representing a sequences of steps associated with corrective processing of the audio embodied in the analog optically recorded variable density sound tract;

FIG. 8A illustrates a diagram representing a soundtrack envelope reproduced with an azimuth error;

FIG. 8B illustrates a diagram representing a soundtrack envelope reproduced with the azimuth error corrected; and

FIG. 9 illustrates a gamma response curve whose X axis represents the values of pixel intensities and the Y axis represents new pixel intensities obtained with various functions.

### DETAILED DESCRIPTION

FIG. 3 depicts a block schematic diagram of a system in accordance with one aspect of the present principles for reproducing and processing an analog optically recorded audio soundtrack on a motion picture film 20. The apparatus of FIG. 3 includes a light source 10 whose light rays project onto the film 20, which includes an audio soundtrack 25, depicted in FIG. 3 with an exaggerated width dimension. The audio soundtrack 25 is optically recorded by means of a variable density recording method.

In a conventional film sound reproducer light from source 10 passes through the film 20 and the track 25 so as to emerge with an intensity varying in accordance with the method employed for exposing the film to record the soundtrack. A photocell or solid-state photo detector (not shown) gathers the varying-intensity light. The photo sensor usually generates a current or voltage in accordance with the intensity of the transmitted light. The analog audio output signal from the photo sensor undergoes amplification and processing to alter the frequency content to improve or mitigate deficiencies in the acoustic properties of the recorded track. However, such frequency response manipulation is generally incapable of remedying the deficiencies without adversely effecting the wanted audio content.

In the inventive arrangement shown in FIG. 3, a fiber optic means (not illustrated) guides light from source 10 to form a projected beam of light for illuminating soundtrack 25. The variable-density soundtrack 25 serves to modulate the light in intensity for collection by an optical group 75. The optical group 75 typically includes a lens assembly, extension tube and bellows (not shown) which are arranged to form an image of the complete soundtrack width across the width of a CCD line array sensor 110 which forms part of a camera 100.

The bellows extension tube and tens of the optical group 75 are accurately adjusted to image the standardized recorded track positions. However, manual adjustments are provided to permit both focusing, exposure and image size adjustment or zoom control to allow the recorded film area to substantially fill the maximum sensor width with a small area of the soundtrack. The mounting system of the camera 100 also facilitates both lateral and azimuth adjustments. A lateral adjustment (L), as seen in FIG. 3, allows imaging of laterally mis-positioned tracks, for example to eliminate sprocket or perforation generated buzz or picture related light spill. Furthermore in severe situations where such a lateral image adjustment fails to eliminate audible sprocket hole or perforation noise, or picture spill, the camera and tens can be adjusted to substantially fill the sensor width with a part of the recorded envelope positioned to avoid the offending illuminating noise source.

The selection of lens and other components of the optical group 75 are determined largely by the audio optical track width and the width of the imager array. An optical track of a 35 mm film has a standardized width of 2.13 mm, and the approximate length of the CCD imager 100 is about 20.48 mm based on a pixel size of 10 microns. Thus to enable the maximum width of a soundtrack of a 35 mm film to fill the imager width requires an image magnification of about 10:1. Similarly for a 16 mm film whose optical track has a width of 1.83 mm, in order to fill the imager width requires the addition of a 56 mm extension tube or bellows.

The Camera 100, for example an Aviiva type M2-CL camera, is controlled by frame grabber (CTRL) 200, for example, Matrox Meteor II CL digital board, which synchronizes the image capture and generation of a 12-bit digital signal representing the line scanned image of soundtrack 25 as the film 20 continuously traverses the projected beam of light. The CCD imager 110 has 2048 pixels and provides a parallel digital output signal 120, quantized to 12-bits and capable of operating with a pixel rate on the order of 60 MHz.

The digital image signal 120 represents 2048 successive measurements across the width of the soundtrack 25, which are captured as a 12 bit gray scale signal representing the instantaneous optical transmission of light through the soundtrack. This continuous succession of track width images (representing transmission/density measurements) undergoes storage, as a continuous digital image of the soundtrack 25, in a storage system 300, depicted as an exemplary RAID system.

Under control of the frame grabber 200 and responsive to user control, the Camera 100 generates its 12-bit parallel digital output signal 120, in accordance with either the CameraLink or RS 622 output signal format. The use of a 2048 pixel line array sensor quantized to 12-bit resolution provides an adequate signal to a quantizing noise ratio of about 74 dB and with a resolution sufficient to capture the soundtrack envelope image without significant frequency response distortion. The frame grabber 200, which controls the camera 100, can provide synchronization to NTSC or HD television sync pulses via sync interface 250, and also permits an output data rate sufficient to capture soundtrack images at normal operating speed of nominally 24 fps.

In addition to the imaging considerations, the desired bandwidth of the processed audio signal must be considered. For example, if a reproduced audio bandwidth of 15 kHz is required, a sampling or image scanning rate of 30 kHz is needed. Thus with an exemplary sampling rate of 30 kHz, the camera 100 will output 2048 pixels represented as 12-bit words for each image scan (audio track line scan) producing an output data rate of 3072*30*10³ or 92.1 mega bytes per second. Hence, one minute of soundtrack requires approximately 5.53 gigabytes of storage. Such storage capacity requirements can be provided by the RAID system 300, which typically comprises an Ultra Wide SCSI 160 drive.

The apparatus of FIG. 3 includes controller 400 that performs one or statistical processing operations on the digital signal stored in the storage system 300 to restore the characteristics of the audio embodied on the soundtrack 25. The controller 400 includes an Operating System (OS), illustratively depicted by block 405, which provides the user with a visual menu and control panel for presentation on a display 500. Responsive to the displayed information, the user can enter information through a keyboard 600 for use by the controller 400 when executing one or more application programs 410 to process the stored digital information.

The controller 400, together with the display 500 and keyboard 600 can comprise a personal computer. Alternatively, the controller 400 could comprise a custom processor integrated circuit, or combination of such circuits, coupled to the display 500 and keyboard 600. Regardless of its form, the controller 400 must support the high transfer rates associated with the camera data and requires at least 512 MB of RAM together with an Ultra SCSI 160 or fiber channel interface that can sustain the high transfer rates. In addition, the controller 400 should ideally include dual processors to allow parallel processing which can increase both processing speed and performance.

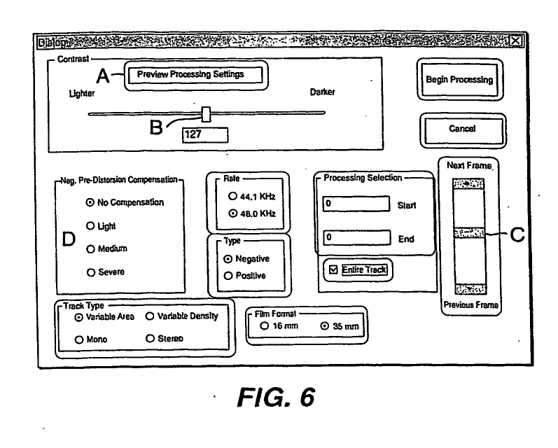

An operator activates the system of FIG. 3 via the keyboard 600 or via mouse selection of an icon (Digital AIR II) which results in a Windows® like control screen arrangement presented on display screen 500, shown in detail in FIG. 6. Various operating modes such as Preview, Record, Stop, Process and Export appear as tool bar functions in a border area of the display. Initially an operator can select Preview mode from the tool bar functions, which advantageously starts the soundtrack in motion and forms a soundtrack image on the display screen 500 of FIG. 3. The gray scale image allows alignment of camera and optics to the recorded soundtrack. The operator can adjust the optical group 75 of FIG. 3 to ensure that the soundtrack image substantially fills the width of the imager 110 and provides good image signal-to-noise ratio by ensuring proper CCD exposure, which can differ between negative and positive prints and is also dependent on the type of film stock.

Advantageously, the real time image provides not only pictures of the soundtrack but also shows the presence of interference generating illumination emanating from the sprocket holes, or the picture area which can contaminate the soundtrack. This unwanted light ingress can be eliminated by using the on-screen camera image to permit manipulation of optical group 75 to remove such unwanted audio contributions by carefully framing the soundtrack using picture zoom, pan and tilt as well as by manipulating the position of the light source with respect to the track. In addition, the soundtrack image can be examined in detail by electronically magnifying selectable sections of the display envelope to permit camera azimuth alignment when reproducing a test film known as a buzz track. The magnified image is presented with an electronically cursor line which permits the evaluation of any perturbations or anomalies in the audio modulation envelope.

Width-optimized azimuth alignment modulation peaks appear concurrently with substantially equal magnitude but opposite polarity. An optimum azimuth adjustment will produce concurrently maximized envelope peaks. Misalignment of azimuth between the camera and the soundtrack can result in an image, which captures temporally different audio information, such as can occur with a stereo audio track pair. FIG. 8A depicts a diagram representing a soundtrack envelope reproduced with an exemplary and exaggerated azimuth error. Appearing in FIG. 8A on the same time axis is a processed or electronically cored image showing the temporal displacement resulting from an azimuth error between the camera imager camera and the soundtrack. FIG. 8B depicts the same envelope image as FIG. 8A but reproduced without an azimuth error, and shown below on the same time axis is the electronically cored image which indicates that the envelope peaks have been scanned substantially concurrently and are of similar amplitudes.

FIG. 5 depicts an example of a Preview mode soundtrack image. The gray scale picture in FIG. 5 comprises a duplicate negative soundtrack, which includes various impairments. For example, on the right side of the soundtrack image unwanted illumination can be seen emanating from film perforations, a defect indicative of misalignment during duplication. In addition, the soundtrack has a reduced width and shows lateral scratches probably incurred on the original negative. This advantageous real time soundtrack image permits rapid visual alignment of the camera and optics, rather that reliance on acoustically determined positioning.

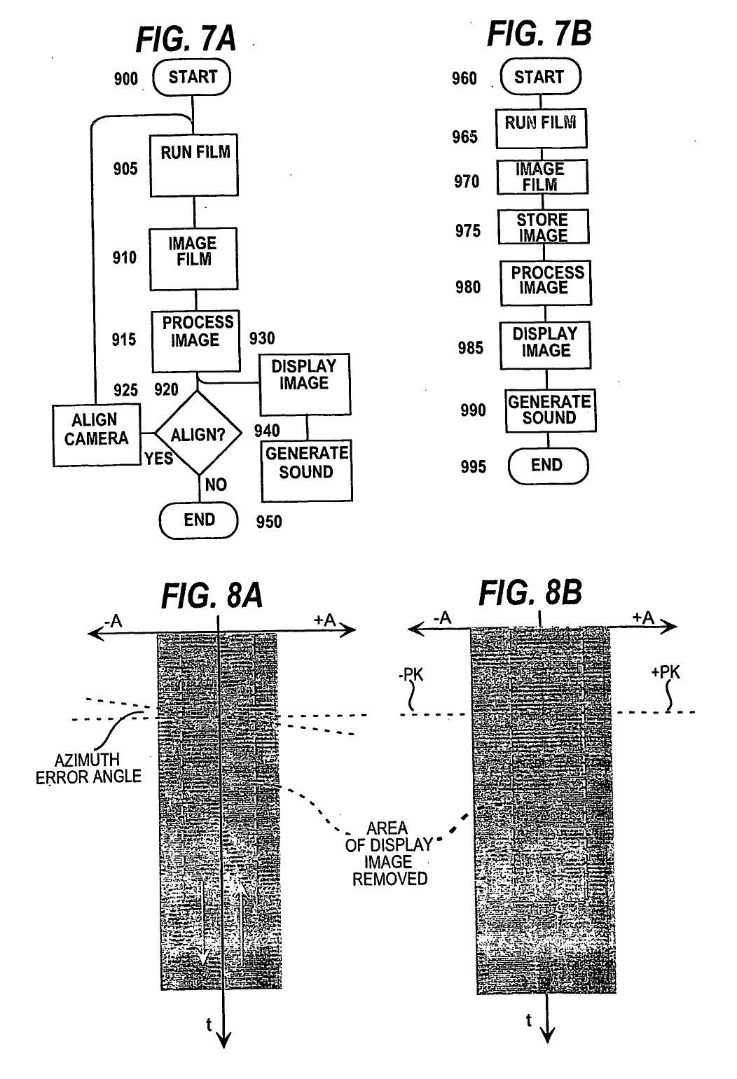

FIG. 7A depicts the steps associated with the scanning alignment sequence. The process commences upon execution of Start step 900, whereupon, initialization occurs. Next, the Preview mode occurs during step 905 with the running of a segment of a test film (i.e., a “buzz track”). The test film segment typically constitutes the worst-case scenario in terms of misalignment. The film undergoes imaging during step 910, typically as the film runs during step 905. The images captured during step 910 undergo processing during step 915 and display during step 930. Sound generation occurs during step 940, whereupon the sequence of steps ends during step 950. Image display and sound generation can occur simultaneously.

Following processing of the image during step 915, a check occurs during step 920 whether the operator should undertake alignment of the camera 100 of FIG. 3, owing to audio imperfections detected upon image display during step 930 and/or upon listening to the sound generated during step 940. If necessary, such alignment occurs during step 925 prior to proceeding to step 905 to re-run the film. Capturing the soundtrack image as a digital signal facilitates permits more accurate alignment, thus allowing substantial elimination of deficiencies resulting from prior misalignment.

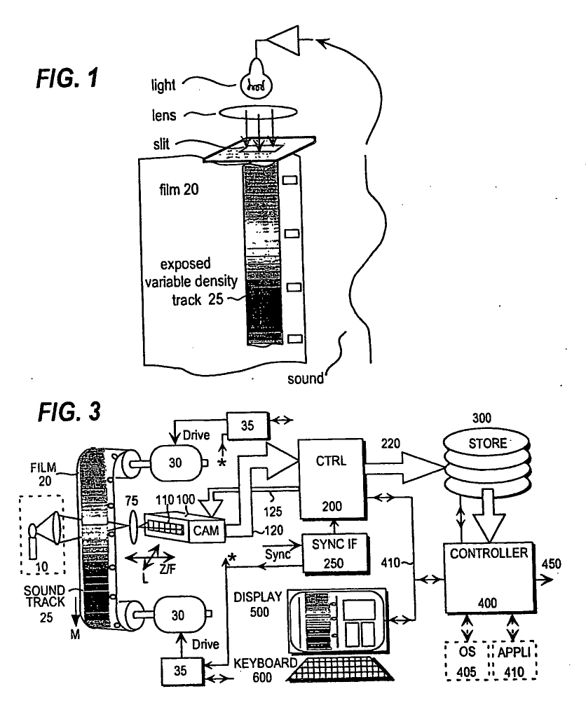

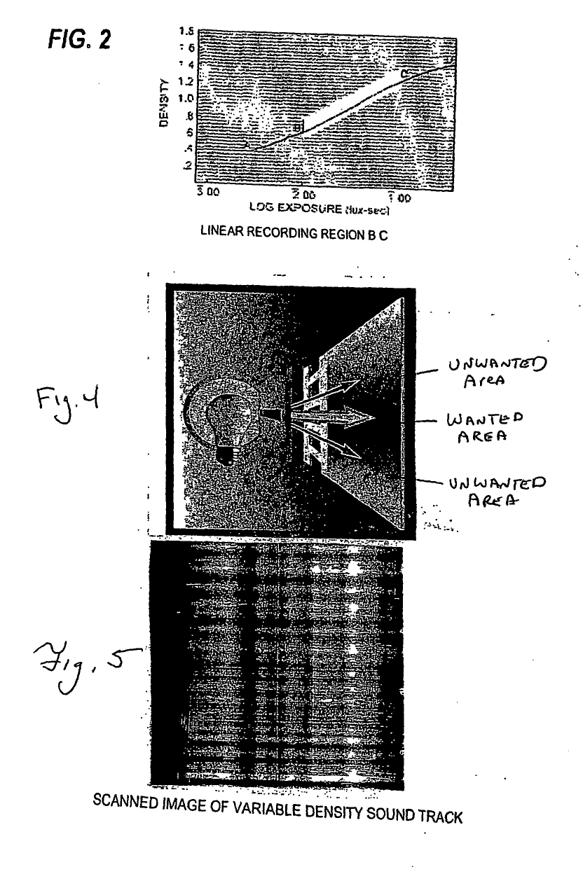

Following camera image optimization, framing, focus, exposure, etc. to reduce misalignment, the operator selects the Record mode the tool bar of FIG. 6 to undertake scanning of the soundtrack 25 of the film 20 (both of FIG. 1) to yield the digitized 12-bit digital signals stored in storage system (RAID array) 300 of FIG. 3. FIG. 7B illustrates a flow chart representing a sequence of steps associated with corrective processing of the audio embodied in the analog optically recorded variable density soundtrack 25 of FIG. 3. The sequence of FIG. 7B commences upon execution of Start step 960, whereupon, initialization occurs. Next, running of the actual film occurs during step 965. The film undergoes imaging during step 970, typically as the film runs during step 965. The captured images undergo storage during step 975. During step 980, the stored images undergo processing to correct the audio deficiencies. The processed images undergo display during step 985. Sound generation occurs during step 990. Sound generation can occur together with the image display. The process ends upon step 995

As described, after completing the scanning and storage steps 970 and 975, respectively, the digital soundtrack image undergoes processing during step 980. Such processing occurs upon operator selection of the Processing mode from the tool bar shown inn FIG. 6. The processing control panel shown in FIG. 6 allows the operator to select and optimize film specific processing to be performed on the stored soundtrack image thereby obviating the potential for damaging the film material during repeated play back for optimization. The operator selects the processing algorithms resident in the controller 400, or as depicted within block 410, from the on-screen menu via the keyboard 600. The controller selectively applies the algorithms to data selectively retrieved from the stored digital image in the storage system 300. The processed and renovated digital signal is converted for outputting as a digital audio signal 450 having a selectable exemplary format such as WAV, MOD, DAT, or DA-88.

As discussed, the processing control panel shown in FIG. 6 allows the operator to select and optimize processing specific to the stored soundtrack image. For example film gauge is selectable, together with the film type, positive or negative and audio modulation method for example, unilateral variable area, bilateral variable area, dual bilateral variable area, stereo variable area or variable density. The advantageous processing algorithms are selected from the on-screen menu and applied to the stored digital image accessed from storage system 300 for processing by the controller 400.

Soundtrack deficiencies can result from the various causes described previously. However, more specifically, dirt, debris, transverse or diagonal scratches or longitudinal cinches in a negative can produce white spots when printed. These flaws generate clicks and crackles. Such white spots tend to affect the dark areas of the track and are more noticeable during quiet passages whereas noise occurring during loud passages often originates in the clear areas of the print. Low frequency thuds or pops often result from relatively large holes or spots in a positive soundtrack formed as a consequence processing problems. Hiss can result from a grainy or slightly fogged track area. A noise envelope that follows the wanted audio signal is often caused by inter-modulation distortion.

Although the scanned audio track is represented as a continuous intensity modulated image, sections of the image can be read from the storage system 300 and configured for processing using statistical techniques. A first algorithm was developed using a computer program such as Matlab® to estimate the instantaneous amplitude value of the audio signal as represented by the density of the film track and digitized as a single line scan. Statistical techniques can be used to estimate the density value that truly represents the amplitude of the audio signal. First, finding the average of the density values in the line vector comprised of 2048 pixel provides a good estimate of the true audio amplitude representation. This averaging process also serves to minimize the effects of unwanted noise resulting from unwanted variations in optical transmission across the track width.

The concept here is to obtain the instantaneous audio amplitude which corresponds to the gray level value of the scanned image in a particular instance by means of adding such gray level values on each and all of the pixels in one scanned line and dividing by the total number of pixels in such line. In this example, there are 2048 pixel elements on the line scan CCD array. Each element will output a gray level that corresponds to the intensity of the audio track in that particular portion of the density track and the track is scanned at 30,000 such lines per second. All of the individual pixel values obtained during the scanning are added and the sum is and divided by 2048, the number of pixels per line, to obtain the mean value to be used as the instantaneous audio level.

Scratches across soundtrack can cause variations in light transmission, which produce transient or impulsive noise effects such as loud pops or clicks. This form of transient noise is advantageously eliminated by a second algorithm which is applied to the line image sections of the stored exemplary 12-bit digital envelope signal. This second algorithm uses a spatial image processing technique to derive the mean values of the pixel of each image section across the width of the track. These mean values are then used to generate the instantaneous audio amplitude of the track. The technique uses regression analysis with a weighted coefficient assigned to pixel values and their relative deviation from the mean. If a pixel has a standard deviation greater than a user set threshold, it is eliminated from the estimation process. In this way a linear approximation of the variations in density across the soundtrack width is obtained. The middle point in the data values across the line is then the mean value used to estimate the amplitude of the audio with very little effect from random noise and transient noise.

Often, density tracks are recorded beyond the linear portion of a film's response extending into the toe and shoulder areas of the gamma curve. To compensate for the amplitude distortion caused by this, an exponential curve can be chosen such that the toe's logarithmic shape can be linearized. A cubic function can be chosen to linearize the audio that falls in the shoulder portion of the gamma curve. Different slopes and lengths can be chosen for each segment and listening test can be performed to determine the best settings.

A vector with 4096 entries is generated to hold the values of the look up table. The 4096 coefficients are computed from the graph that was previously defined by the operator in the following manner: The N entry on the vector is calculated as N=F(X). In the case of the exponential function N=e^{x} or in the linear portion N=Slope*X+intercept where X is the pixel intensity value. With a pre-calculated look up table the new intensity value N for a pixel X can be obtained without spending processor time evaluating the functions for each pixel.

A further advantageous arrangement utilizes look up tables to provide compensation for pixel intensity values that are occur in the non-linear toe and shoulder areas of the film transfer characteristic. The look up table provides linearizing correction values for densities that extend beyond the normal linear region of the film characteristics. A computer routine maps a Linear density value that corresponds to the mean amplitude values calculated with the previous methods if it falls within the non-linear range of the film. The net result is an increase in the dynamic range and signal-to-noise ratio of the audio signal.

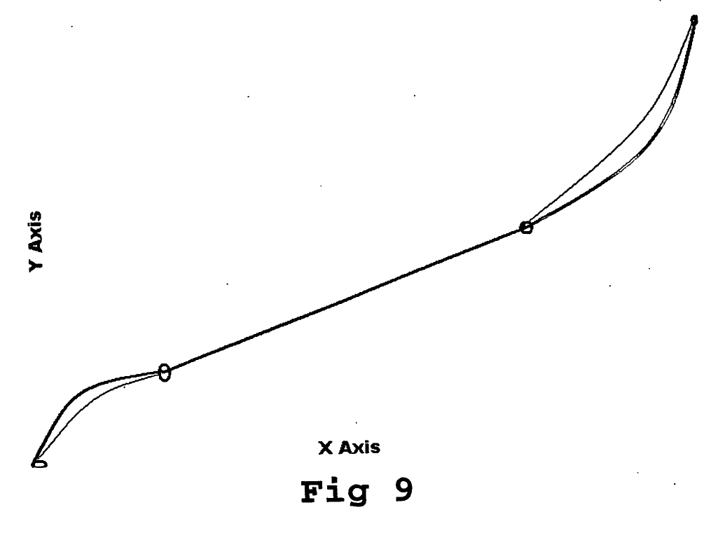

This technique seeks to linearize the non-linear portions of the gamma response curve for an audio film. An operator is provided with an interface, as seen in FIG. 9 with a gamma response curve whose X axis represents the values of pixel intensities between 0 and 4095 (Twelve bit) and the Y axis represents new pixel intensities obtained with various functions. The graph described inside the X-Y plane represents these functions as they are applied to different ranges of pixel values. This graph is divided into at leas three segments by defining four points shown. Each one of these segments can then be chosen to have its own shape including linear, cubic or exponential to mention some examples. This graph is then used to create a look up table to be used in the processing of all of the pixel intensities in the imaged audio density track. The user can not only select the shape, but also the slope of each segment of the graph by clicking in the circled points on the graph and moving them horizontally or vertically.

As discussed previously, the statistical processing performed by the processor 400 can include regression analysis. Again, the idea is to linearize the gamma response of the variable density audio track. In this case, linear regression is used to interpolate the pixel values that lie in the toe, shoulder and any other areas that are non linear. First, a data set of all the intensity values present in the track are gathered. Then, a least square fit is performed on that data set and obtain the slope and intercept for the gamma response that best approximates the track and use that curve to create a look up table in the same manner described above. In this case, the value N=slope*X+intercept, where the slope and intercept are the values obtained from the linear least squares.

Another statistical processing technique capable of being implemented by the controller 400 of FIG. 3 is adaptive filtering to minimize the effects of inter-modulation distortion. To minimize the effects of inter-modulation distortion in a variable density track, the “extra” densities caused by light bleed around the masking slit in the negative recorder must be subtracted. Since this light bleed has a sinusoidal decay, a portion of the gamma that is dependent on the exposures prior and following a given area must be subtracted. Since a continuous scan of the entire track exists on the hard disk, the samples prior and following any sample are available. The user can experiment with some angles for the sin function and the constants beta and kappa in the equation below and perform listening tests to choose the best sounding settings for the filter.

$${A}_{ik} = ( \sum β {A}_{k - 1} Sin ( {wt}_{k} + ϕ ) + β {A}_{k - 2} Sin ( {wt}_{k} + ϕ ) + β {A}_{k - 3} Sin ( {wt}_{k} + ϕ ) + … + β {A}_{k - n} Sin ( {wt}_{k} + ϕ ) ) + ( \sum κ {A}_{k + 1} Sin ( {wt}_{k} + ϕ ) + κ {A}_{k + 2} Sin ( {wt}_{k} + ϕ ) + κ {A}_{k + 3} Sin ( {wt}_{k} + ϕ ) + … + κ {A}_{k + n} Sin ( {wt}_{k} + ϕ ) )$$

During initial camera alignment the track image is observed at several film locations and if film weave is apparent the image centering can be adjusted to position the nominal center of wandering soundtrack path in the middle of the display image. The image size is then adjusted such that the audio track fills the width of the CCD line array. Hence it can be appreciated that as the film weaves only the horizontal position, or distribution of the end pixels vary. However, mean of the pixel intensities, which represent the audio signal amplitude, remains substantially constant because although the intensity envelope image moved it remained on the sensor array. Thus the algorithm for converting the envelope image into an audio value advantageously eliminates and corrects the effects of film weave.

The foregoing describes a technique for restoration of recorded signal quality in variable density recordings on motion picture by scanning the soundtrack to yield a digital signal and then applying statistical processing techniques on such a signal.

What is claimed is:

1. A method for restoring audio information embodied within an analog, optically-recorded variable density soundtrack of a film, comprising the steps of:
optically scanning the soundtrack to yield a digital signal representation of the audio information;
storing the digital signal;
applying at least one statistical processing technique to the stored digital signal to restore at least one characteristic of the audio information.

2. The method according to claim 1 wherein the optically scanning step further comprises the step of scanning successive lines of the soundtrack.

3. The method according to claim 2 wherein the step of applying the at least one statistical processing technique further includes performing at least one of the following operations:
(a) averaging pixel intensities over each scanned line;
b) calculating a standard deviation of each pixel in each line scan, eliminating pixel values that deviate above a user defined threshold, and calculating mean to obtain a noise reduced instantaneous amplitude;
c) creating a look-up-table to correct for data values derived from non-linear areas of film density transfer characteristic;
d) performing statistical and regression analysis of the pixel intensities values to extend beyond non-linear areas of film density transfer characteristic; and
e) performing adaptive filtering to minimize effects of inter-modulation distortion.

4. The method according to claim 3 further comprising the step of performing one the operations in response to operator selection of said one operation.

5. The method according to claim 3 further including the step of performing a plurality of operations.

6. The method according to claim 3 further including the step of performing all of the operations.

7. The method according to claim 1 further including the step of quantizing the digital signal to at least 12-bit resolution.

8. The method according to claim 2 further including the step of synchronizing the scanning of successive lines to movement of the soundtrack to yield a prescribed number of line scans per unit of time.

9. The method according to claim 2 wherein the step of scanning successive lines of the soundtrack further comprises the step of displacing the film relative to a line scan camera.

10. The method according to claim 9 further including the step of aligning the line scan camera with respect to the soundtrack so that the soundtrack substantially fills a width of the line scan camera.

11. The method according to claim 9 further including the step of azimuth aligning the tine scan camera so that equal density values of the soundtrack, when displayed concurrently, appear with substantially equal brightness.

12. The method according to claim 9 further including the step of aligning the soundtrack relative to the line scan camera so that any positional variation of an audio representative envelope of the soundtrack remains within a digital image of the soundtrack.

13. The method according to claim 3 wherein the step of creating a look-up table further includes the step of mapping a linear density value to a mean amplitude value if the mean value falls in a linear range.

14. The method according to claim 3 wherein the step of performing adaptive filtering includes choosing an empirical filter value Aᵢₖ in accordance with the formula:
$${A}_{ik} = ( \sum β {A}_{k - 1} Sin ( {wt}_{k} + ϕ ) + β {A}_{k - 2} Sin ( {wt}_{k} + ϕ ) + β {A}_{k - 3} Sin ( {wt}_{k} + ϕ ) + … + β {A}_{k - n} Sin ( {wt}_{k} + ϕ ) ) + ( \sum κ {A}_{k + 1} Sin ( {wt}_{k} + ϕ ) + κ {A}_{k + 2} Sin ( {wt}_{k} + ϕ ) + κ {A}_{k + 3} Sin ( {wt}_{k} + ϕ ) + … + κ {A}_{k + n} Sin ( {wt}_{k} + ϕ ) )$$

15. A system for restoring audio information embodied within an analog optically recorded variable density soundtrack of a film, comprising the steps of:
a optical scanner for scanning the soundtrack to yield a digital signal representation of the audio information;
a storage system for storing the digital signal;
a processor for applying at least one statistical processing technique to the stored digital signal to restore at least one characteristic of the audio information.

16. The system according to claim 15 wherein the optical scanner comprises a line scan camera for scanning successive lines of the soundtrack.

17. The system according to claim 15 wherein the processor performs at least one of the following statistical processing operations:
(a) averaging pixel intensities over each scanned line;
b) calculating a standard deviation in each line of scanned data to eliminate extraneous pixel values.
c) calculating the standard deviation of each pixel in each line scan, eliminating pixel values that deviate above a user defined threshold, and calculating mean to obtain a noise reduced instantaneous amplitude;
d) creating a look-up-table to correct for data values derived from non-linear areas of film density transfer characteristic;
e) performing statistical and regression analysis of the pixel intensities values to extend beyond non-linear areas of film density transfer characteristic; and
f) performing adaptive filtering to minimize effects of inter-modulation distortion.

18. The system according to claim 17 wherein the processor performs one of the statistical processing operations in response of operator selection of said one operation.

19. The system according to claim 17 wherein the processor performs a plurality of statistical processing operations.

20. The system according to claim 17 wherein the processor performs all of the statistical processing operations

21. The system according to claim 16 wherein the line scan camera yields a quantized digital signal having at least 12-bit resolution.

22. The system according to claim 16 further including means for synchronizing the scanning of successive lines of the soundtrack by the camera to movement of the soundtrack to yield a prescribed number of line scans per unit of time.

23. The system according to claim 16 further including means for displacing the film relative to the line scan camera.

24. The system according to claim 16 further including means for aligning the line scan camera with respect to the sound rack so that the soundtrack substantially fills a width of the line scan camera.

25. The system according to claim 16 further including means for azimuth aligning the line scan camera so that equal density values of the soundtrack, when displayed concurrently, appear with substantially equal brightness.

26. The system according to claim 16 further including means for aligning the soundtrack relative to the line scan camera so that any positional variation of an audio representative envelope of the soundtrack remains within a digital image of the soundtrack.
